(19) United States
(12) Patent Application Publication
(10) Pub. No.: US 2014/0051506 A1
(43) Pub. Date: Feb. 20, 2014

(54) Gamification for Enterprise Architectures

(71) Applicants: Michael Ameling, Dresden (DE); Philipp Herzig, Dresden (DE)

(72) Inventors: Michael Ameling, Dresden (DE); Philipp Herzig, Dresden (DE)

(73) Assignee: SAP AG, Walldorf (DE)

(21) Appl. No.: 13/586,507

(22) Filed: Aug. 15, 2012

(51) Int. Cl. G06F 19/00

(52) U.S. Cl. 463/29

(57) ABSTRACT

A gamification system to gamify an enterprise includes a gamification platform and a message broker. Users in the enterprise may participate as players in the gamification platform. Enterprise information systems of the enterprise may communicate events to the message broker. Gamification rules may be expressed in terms of events and game context. The gamification platform may reason over events in accordance with the gamification rules and the current context of game play in order to trigger a proper consequence.

### BACKGROUND

Unless otherwise indicated herein, the approaches described in this section are not prior art to the claims in this application and are not admitted to be prior art by inclusion in this section.

Gamification is an evolving technique by which game mechanics are applied to non-gaming applications in order to increase user engagement, motivation, and participation. This approach is especially promising in the enterprise domain since enterprise information systems (EIS) focus mainly on efficiency aspects rather than individual long-term motivation and enjoyment. Prior research has shown that these latter variables lead to higher positive organizational outcomes, e.g., job performance. Initial gamification attempts have been successfully implemented and show promise. However, existing gamification platforms are typically designed for business-to-consumer (B2C) purposes, require high integration effort, and lead to silo-based applications.

### BRIEF DESCRIPTION OF THE DRAWINGS

FIG. 1 shows an illustrative embodiment of a gamification system in accordance with the present disclosure.

FIGS. 2A, 2B, and 2C illustrate typical enterprise architectures that may be integrated in the gamification system of the present disclosure.

FIG. 3 illustrates an example of a gamification system integrated with enterprise information systems.

FIG. 3A illustrates an example of distributed gamification data.

FIGS. 4 and 4A illustrate a design workflow in accordance with the present disclosure.

FIGS. 5 and 5A illustrate a runtime workflow in accordance with the present disclosure.

FIG. 6. shows a high level diagram of an illustrative implementation of a gamification system of the present disclosure.

### DETAILED DESCRIPTION

Disclosed embodiments relate to gamification platforms and methods to gamify enterprise information systems without negatively affecting existing system landscapes. In the following description, for purposes of explanation, numerous examples and specific details are set forth in order to provide a thorough understanding of the present disclosure. It will be evident, however, to one skilled in the art that the present disclosure as defined by the claims may include some or all of the features in these examples alone or in combination with other features described below, and may further include modifications and equivalents of the features and concepts described herein.

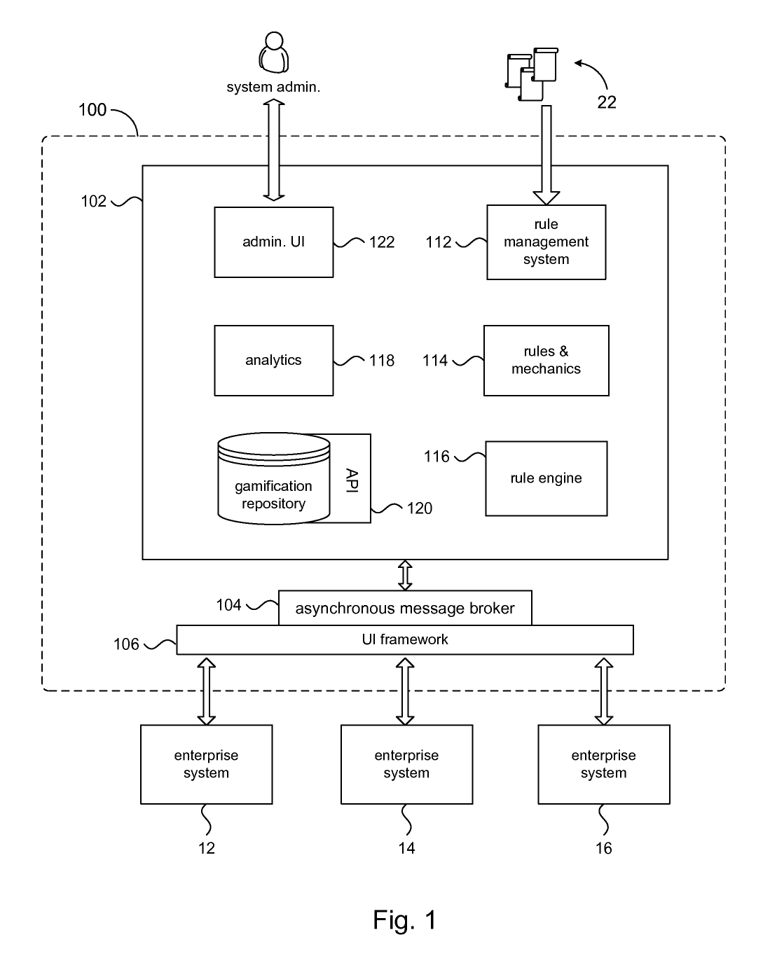

FIG. 1 shows an illustrative example of a gamification system 100 configured in accordance with embodiments of the present disclosure. The gamification system 100 comprises several components to gamify one or more enterprise information systems 12, 14, 16 deployed in an enterprise. In some embodiments, for example, the gamification system 100 comprises a gamification platform 102 and an asynchronous message broker 104. The message broker 104 may serve to connect the external and separate enterprise information systems 12-16 to the gamification platform 102 via a user interface (UI) framework 106.

The gamification platform 102 may comprise a rule management system (RMS) 112, a rules & mechanics component 114, a rule engine 116, an analytics component 118, and a gamification repository 120. As will be explained in more detail below, the RMS 112 may receive gamification rules 22 from a source external to the gamification system 100 and manage the gamification rules on behalf of the gamification platform 102. The RMS 112 may manage multiple sets of gamification rules 22 for separate different versions of gamification rules, administer incremental changes to the gamification rules, and so on. In some embodiments, different sets of gamification rules 22 may be provided to emphasize or test different motivational or behavioral designs. An example of gamification rules 22 is shown in the Appendix at the end the specification.

In accordance with principles of the present disclosure, “gamification rules” will be understood to incorporate aspects of an enterprise that govern the management and operations of the enterprise. For example, in addition to traditional notions of gaming rules, gamification rules 22 may include business rules and business processes which model and describe the behavior of the enterprise that is being gamified. Gamification rules 22 may incorporate policies and procedures (whether internally developed or externally imposed) that govern various operations in the enterprise. Gamification rules 22 may incorporate actual elements from the enterprise into the game such as physical facilities, locations, incentive programs, and so on. By incorporating aspects of the enterprise into the game this way, the gaming environment becomes a familiar landscape for players thus encouraging employees in the enterprise who may be reluctant to play or are uncomfortable with games to participate in the game.

The RMS 112 may deploy the gamification rules 22 into the rule engine 116. In some embodiments, the RMS 112 may inform the rule engine 116 which set of gamification rules 22 to use. In a particular embodiment, for example, a common shared location in a main memory or a common shared data storage location may be used to specify which gamification rules 22 are in play. Accordingly, if the RMS 112 receives new gamification rules or changes to existing gamification rules, the RMS may point the rule engine 116 to the new/changed gamification rules using the common shared data location. In some embodiments, the RMS 112 may manage gamification rules 22 that reside on one or more remote storage systems, separate from the gamification system 100. Accordingly, the RMS 112 may point the rule engine 116 to any remote systems that contain all or portions of the gamification rules 22.

The rules & mechanics component 114 may provide various game mechanics for supporting game play. Game mechanics may include tools for creating artifacts in the game and the accompanying logic for how to interact with the artifacts. The game mechanics may provide an infrastructure for rewarding players with award points (experience points, etc.), to mediate commerce (e.g., provide a marketplace, purchasing items, bartering between players, etc.), to communicate among players, and so on. The game mechanics infrastructure may allow for monitoring players in the game; for example, tracking player progress, announcing achievements (e.g., “player X is winner of the month”), providing a leader board, and so on. The game mechanics infrastructure may include functionality for monitoring events, such as timers to time events and player actions, location sensors to detect player movement and locations, sensors to track game conditions (e.g., a treasure chest is open), and so on.

In some embodiments, the rules & mechanics component 114 may support cooperative game play among players toward a common goal. The rules & mechanics component 114 may support competitive game play. Support may be provided for team formation where teams play toward a common goal or play against competing goals. The rules & mechanics component 114 may provide a communication platform for private communication among team members and communication between teams.

The analytics component 118 may analyze player behavior in order to improve the gamification rules 22 and optimize long-term engagement. The analytics component 118 may analyze historical data, for example, to compute player participation rates, player visit rates, and other such metrics. Player achievements, performance statistics, and other qualitative or quantitative game data may be computed. The analysis may be used to identify where the gamification rules 22 may be improved to enhance motivational elements in the game, increase player participation, and so on. The analytics component 118 may include data mining capability to conduct deeper analytics to identify trends, patterns, and so on as additional tools for improving the game design.

The gamification repository 120 may be a persistent data store for storing runtime aspects of the gaming platform 102. The gamification repository 120 may also store the game's environmental information such as maps, game items, game creatures, and so on. The gamification repository 120 may track players who are in the game, their IDs, alter ego information (e.g., game name, avatar, etc.), achievements, current gamification state, and the like. The gamification repository 120 may store gamification state information and player state information to allow the gaming platform 102 to operate in a stateful manner.

In some embodiments, the gamification repository 120 may provide an application programming interface (API) to provide computational access to the data stored in the gamification repository. For example, the gamification repository 120 may include a set of “query” APIs which may be used by other elements of the gamification platform 102 to perform complex computations of gamification state based on updates made to low level gaming data. For example, the rule engine 116 may request the sum of a player's accumulated points, which the rule engine may then use as an input when processing a rule. The rule engine 116 may request such a computation from the gamification repository 120, for example, each time that a player accumulates a point. If the gamification repository 120 responds with a result of “50”, that may trigger the rule engine 116 to award the player with a “gold customer” badge.

The gamification repository 120 may include a set of “update” APIs to store progress events (discussed below) from the rule engine 116, thus updating the gamification state. In some embodiments, the update APIs may provide functionality to perform simple to complex consistency checking in order to ensure consistency of the data with respect to gamification semantics. For example, a “point” earned by a player is not just any point, but rather may be an experience point, a redeemable point (e.g., a form of currency), karma points, skill points, reputation points, and so on. Each kind of point has its own semantics. For example, a player's experience points should increment when the player makes an achievement (e.g., achieves the highest sales numbers for the month). The update APIs may check the data to ensure consistency of the data in the context of the gamification semantics before the data is persisted in the gamification repository 120.

The message broker 104 provides an interface between the external enterprise information systems 12-16 and the gamification platform 102. In accordance with principles of the present disclosure, the message broker 104 may operate asynchronously. More specifically, the message broker 104 may send messages to the enterprise information systems 12-16 independently of receiving messages from the enterprise information systems. Similarly, the message broker 104 may send messages to the gamification platform 102 independently of messages received from the gamification platform.

A UI framework 106 may be provided to connect players to the gamification system 100 for player interactions with the gamification platform 102. The UI framework 106 is an integrative aspect of the entire gamification platform 102. For example, basic functions such as communication with the message broker 104 and processing of message events from/to the gamification system 100 may be provided to support the seamless capturing of events without additional implementation effort. The UI framework 106 may provide basic gamification widgets such as turning the game on and off, automatic connection to the gamification platform 102, and so on. The UI framework 106 may allow players to define their own widgets, customize their avatars, and modify other player-related metadata. In some embodiments, a third party may develop widgets and avatars for distribution to players.

The UI framework 106 may be configured for integration into any given frontend or frontend technology, including different computing platforms and operating systems. In addition to providing seamless integration of the target platform (e.g., mobile device, computer tablet, etc.) with a gamification backend, the UI framework 106 may provide easy-to-use and customizable gamification widgets (e.g., profiles, leader boards, progress bars, etc.) for use on the target platform, including configuration and adaptation when the configuration and gamification rules may change.

In some embodiments, the UI framework 106 may notify players using push technology so that players can be notified without the player having to poll the gamification system 100. The UI framework 106 may be provided as a software development kit (SDK), for example for development on smart phones such as the iPhone® smart phone, an Android® brand smartphone, and the like. The UI framework 106 may comprise development systems for desktop computers, such as Adobe® Flash® Player, the Microsoft® Silverlight® development tool, the SAP® Web Dynpro™ modeling tool, and so on.

The gamification platform 102 may include an administrative user interface 122 to allow a system administrator to manage the gamification system 100. For example, players may be added or deleted from the system. The gaming environment may be managed. For example, elements that are relevant to the enterprise business and operations may be added to the gaming environment or otherwise managed; e.g., changing sales thresholds for winning points, adding new challenges and prizes, and so on. The administrator may manage the gamification rules 22; e.g., modify the gamification rules, install new versions, etc.

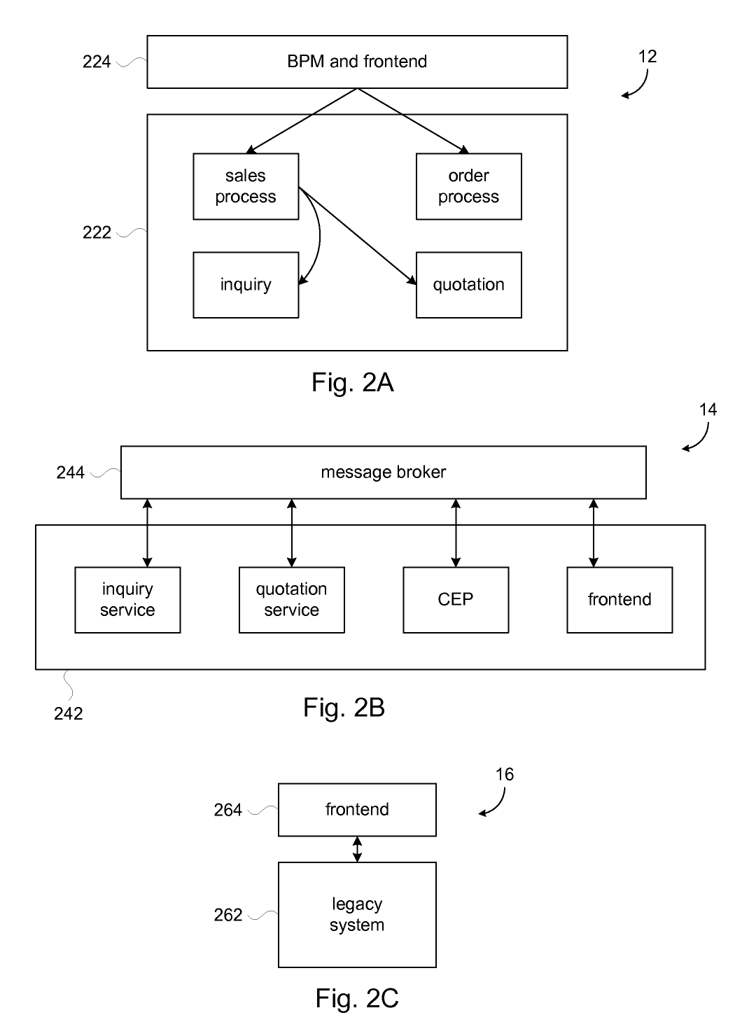

Referring now to FIGS. 2A-2C, a brief description of various enterprise information system architectures will be discussed. In accordance with principles of the present disclosure, gamification system 100 provides a generic platform to gamify enterprise information systems deployed in an enterprise. FIG. 2A illustrates an enterprise information system 12 that is based on an architecture generally referred to as a service oriented architecture (SOA). An SOA configured enterprise information system typically comprises a network of autonomous and interoperable processes and services. The SOA enterprise information system 12 illustrated in FIG. 2A, for example, comprises a configuration 222 of elements such as a sales process and an order process. The configuration 222 may include an inquiry service and a quotation service to support the sales process. The sales process may interact with the order process to complete the sales transaction. A module 224 may provide a business process management (BPM) model that orchestrates the interactions among the elements in the configuration 222. The module 224 may also include frontend elements to facilitate access to the processes in the configuration 222; e.g., a terminal UI, a mobile device, web-based services based on the simple object access protocol (SOAP), web services description language (WSDL), etc. for Internet access, and so on.

FIG. 2B illustrates an enterprise information system 14 that is based on an architecture generally referred to as an event driven architecture (EDA). An EDA configured enterprise information system typically comprises a configuration of elements that communicate by sending events. The EDA enterprise information system 14 illustrated in FIG. 2B, for example, comprises a configuration 242 of elements including an inquiry service, a quotation service, and frontend elements. The elements in configuration 242 act either as an event publisher (event sources) or an event listener (event sinks). A message broker 244 dispatches published events to all interested subscribing elements. Rules for dispatching events can be externalized via a complex event processor (CEP).

FIG. 2C represents a generic enterprise information system 16 that is not structured. Enterprise information system 16 may be a monolithic block of arbitrarily complex functionality 262. Such “legacy” systems, for example, may have been pieced together over time in an ad hoc fashion without a structured design to guide their evolution. A frontend module 264 may comprise user interface (UI) terminals, web services interfaces, and so on.

FIGS. 2A-2C represent a spectrum of enterprise information system architectures that can be deployed in gamification system 100. Some enterprise information systems may fall in one of these categories, but more likely, an enterprise information system may be some combination of them.

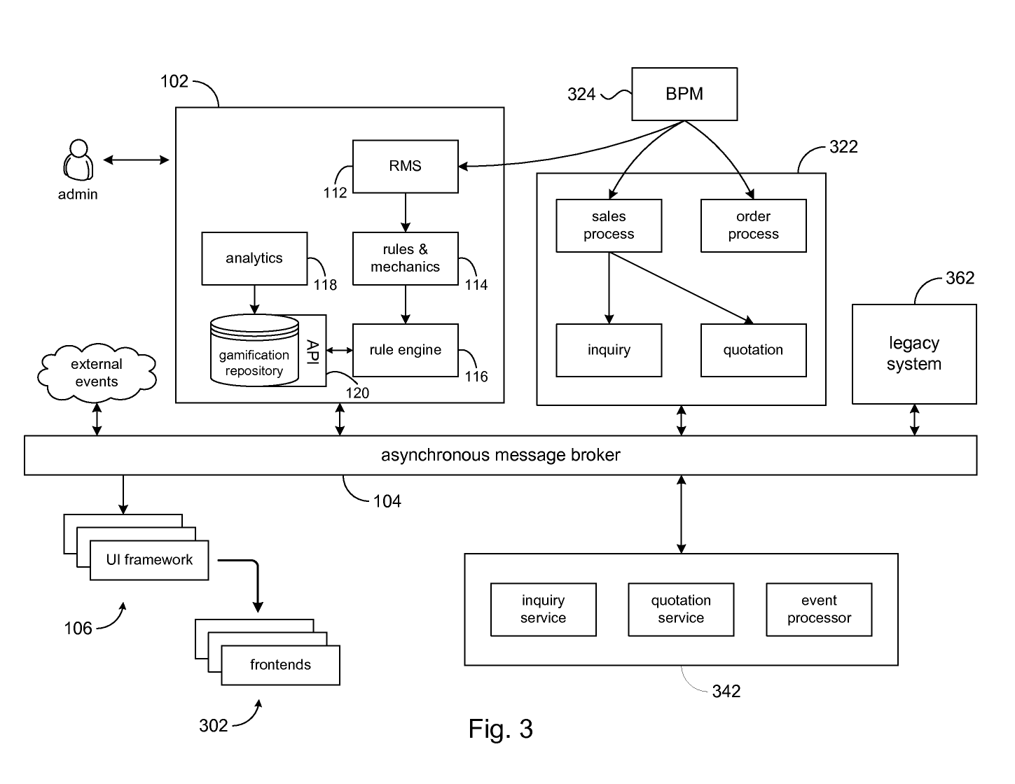

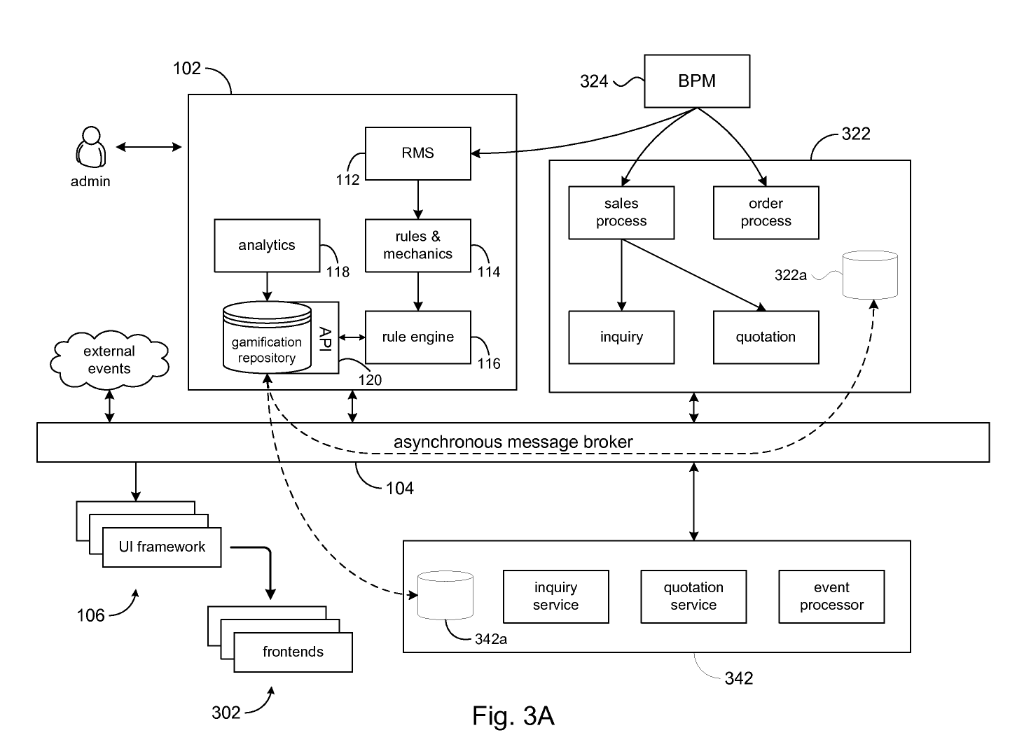

FIG. 3 depicts an illustrative embodiment of the integration of a gamification system with various architectures of enterprise information systems. The figure represents a generalized usage scenario where the gamification system is integrated in a hypothetical enterprise which has deployed an SOA architected enterprise information system 322, an EDA architected enterprise information system 342, and a generic enterprise information system 362. It will be appreciated, of course, that in other integration scenarios, the enterprise may deploy only one architecture, or the enterprise may deploy some combination of architectures.

In accordance with the present disclosure, everything that is relevant to game processing in the gamification platform 102 may be represented by events relating to the enterprise information system(s) 322, 342, 362. For example, if a user/player u in the enterprise successfully completes a step x in a process p, then an event e exists. The “user” may be a person, but may also be an abstraction representing a group of users, a department, machinery, etc. Following is a formal definition of events in accordance with some embodiments:

E=e₁, . . . ,eₙ,

where E is the set of all enterprise events eᵢ. In accordance with the present disclosure, an event may occur within the enterprise; e.g., a sales person has reached a sales goal, manufacturing output has reached a certain limit, and so on. Events may occur outside of the enterprise, but are otherwise related to the enterprise; e.g., the number of customer complaints has exceeded some threshold, the delivery of parts for manufacturing is consistently late, and so on.

In some embodiments, an event eᵢ may be defined as a 6-tuple:

[symbol]

U,Tₛ,D,C,P [symbol] ,

where
U is a set of user IDs representing one or more users involved in event eᵢ,
Tₛ is a timestamp representing the time of event eᵢ,
D represents a duration of event eᵢ,
C is a set of causal events associated with event eᵢ where C⊂E, and

P is a set of m additional parameters associated with event eᵢ with P={pᵢ₁, . . . , pᵢₘ}.

The causal events C constitute a set of already-occurred events that have given rise to event eᵢ, while the parameter set P further characterizes and describes the event eᵢ. The number m of parameters in P may vary from one event to another. The number n of events in E will increment by “1” with each occurrence of an event.

As explained above, the RMS 112 manages the gamification rules 22 for the gamification platform 102, and deploys or otherwise loads the gamification rules into rule engine 116 for processing. A set of gamification rules R may comprise n rules rᵢ, and may be formally represented by the following:

R=(r₁, . . . ,rₙ).

Each rule rᵢ may be formulated as an if-then condition:

rᵢ≡pᵢ [symbol] cᵢ,

where
pᵢ is an i^{th} premise for the i^{th} rule and
cᵢ is an i^{th} consequence that is immediately executed (triggered) when premise pᵢ evaluates to TRUE.

The premise pᵢ may be an arbitrarily complex logical expression that, when evaluated to TRUE, triggers consequence cᵢ. In accordance with principles of the present disclosure, a premise pᵢ may be represented by a set Cⁱ of m patterns:

C_{j:1 . . . m}ⁱ,

which constitute the β-nodes of a generalized Rete graph. The j^{th} pattern C^{i, j} of the i^{th} premise pⁱ may comprise some number n(j) of constraints:

σ_{k:0 . . . n(j)}^{i,j},

which define the α-nodes of the generalized Rete graph. Following are some examples of constraints:

σ₁^{1,1}≡player.level=43

σ₂^{1,1}≡player.age>50

σ₁^{1,2}≡event.type=“startedSale”

σ₂^{1,2}≡event.duration=50 s

σ₁^{1,3}≡event.type=“wentHomeYesterday”

σ₂^{1,3}≡event.time>“23:00”

An LR(k) grammar allows arbitrary patterns C^{i,j} of premise pⁱ to be expressed using temporal and spatial Boolean logic; for example:

C^{1,1}=σ₁^{1,1} AND σ₂^{1,1} OR σ₃^{1,1},

C^{1,2}=σ₁^{1,2} AND NOT σ₂^{1,2},

C^{1,3}:=NOT (σ₁^{1,3} AND σ₂^{1,2}) XOR σ₃^{1,3} AFTER [0,6]σ₂^{1,2}.

As can be appreciated from the small sampling of examples above, the grammar may provide a full set of Boolean operators and comprehensive expressive capability to express logic of arbitrary complexity.

In accordance with principles of the present disclosure, the grammar allows for gamification rules 22 that can recognize and trigger a consequence based upon any kind of event and any pattern of events. The events may originate from the enterprise vis-à-vis the enterprise information systems 12-16 or from external sources. Events may be location specific (spatial) or time specific (temporal). Gamification rules 22 may be based on events that are defined based on where an action occurred (spatial events) or based on when an action occurred (temporal event). Patterns of events may relate to events that occur at different points in time. For example, a first event may set a trigger (e.g., a user purchase a public transportation pass such as a bus pass). However, the trigger may not result in a consequence (e.g., user is awarded a point) until a second event occurs, such as when the user actually uses the public transportation pass. Patterns of events may relate to events that are location specific. For example, a first event that occurs at location A may not result in a consequence until a second event occurs at location B.

In accordance with principles of the present disclosure, the grammar further allows for gamification rules 22 that can recognize and trigger a consequence based on patterns of events that are logically connected. Merely as an example, a gamification rule may recognize the occurrence of event A and event B, but not recognize only event A or only event B. The logic may incorporate temporal relationships. For example, event A must be followed by event B within 10 days. The logic may incorporate a spatial relationship. For example, the gamification rule may recognize the occurrence of event A at location A and the occurrence of event B at location B as a precondition for triggering a consequence.

In accordance with principles of the present disclosure, the grammar further allows for gamification rules 22 expressed in terms of patterns of events which incorporate the current state (gamification state) or context of the game and/or the current state or context of a player or a group of players. For example, a gamification rule may recognize the occurrence of an event A, but only when a player is at a particular location or only when the player as 100 or more experience points. A gamification rule may recognize an event when all the players in a group have solved a puzzle, or when more than five players have reached a given sales quota, and so on. A gamification rule may use logical expressions to specify events in terms of time, space, and current gamification state of the game environment and players.

Continuing with FIG. 3, the message broker 104 may provide suitable APIs to facilitate integration with an enterprise information system. For example, the message broker 104 may provide message conversion routines to convert messages from the EDA architected enterprise information system 342 to a format that is suitable for the gamification platform 102. In the case of the SOA architected enterprise information system 322, the message broker 104 may provide message generating routines that allow a developer of the SOA architected enterprise information system to generate suitable messages that they can send to the gamification platform 102.

In the case of legacy system 362, a more full-featured API may be provided to accommodate enterprise information systems of arbitrary design. The legacy system 362 may be viewed as being one abstraction step higher than an EDA or SOA architected system because it is not likely that any assumptions can be made about its internal structure. For example, the legacy system 362 may not have adequate documentation, or may have no documentation. The customer who has a legacy system may be reluctant to allow inspection of the system software for fear of “breaking” the system, the system may not be easily probed, and so on. Nonetheless, in some embodiments, aspect oriented modules may be provided which are weaved into bytecode within a virtual machine which can capture events from the legacy system 362 without touching it.

In some embodiments, the enterprise information systems 322, 342, 362 may provide suitable frontends 302 with processing capabilities to interface with the message broker 104. For example, the frontend of an enterprise information system 322 may include a web services interface for each of the processes (sales process, order process, etc.) comprising the enterprise information system. The web services interface may send event messages into the message broker 104 as event occur. In other embodiments, the frontend 302 may be a mobile device that connects a player to the enterprise information system as well as the message broker 104.

As mentioned above, the UI framework 106 may connect players to the gamification system 100 for player interactions with the gamification platform 102. The UI framework 106 may comprise communication API's that the frontend 302 can use to communicate with the message broker 104 so that the player may receive events from the gamification system 100 and, conversely, so that the player can issue gamification relevant actions into the gamification system; e.g., the player has clicked on button X, marked a text as bold, accessed the solution after 10 pm for the third time, and so on.

In accordance with the present disclosure, the API provided by the message broker 104 may include other supporting functionality. For example, the API may provide data model transformation and data format transformation, in addition to the protocol transformations described above. Other functionality may include anonymizing certain sensitive data, filtering personal data, mediation with services provided by the enterprise information system, providing security measures, controlling the distribution of event messages, and so on. The message broker 104 may incorporate best practices policies, human resource policies, and other relevant governing policies of the enterprise into its logic to properly handle event messages.

As shown in FIG. 3, in some embodiments, arbitrary external events may be captured by the message broker 104 and provided to the gamification platform 102. In the case of external events, however, APIs may be provided to allow external actors to capture the external events and communicate them to the message broker 104. For example, a source of an external event may be in a customer's system, a news portal, etc.

In addition to receiving event messages from the message broker 104, the gamification platform 102 may send “progress” event messages into the message broker. Processing of the gamification rules 22 by the rule engine 116 may trigger one or more such progress event messages. For example, if a player achieves some predefined goal (e.g., reaches a sales quota), the player may be rewarded with experience points, a badge, virtual currency, etc. The rule engine 116 may generate a progress event message to record such an event. More generally, the rule engine 116 may generate progress event messages to indicate any change in the gamification state as game play progresses. Progress event messages may be stored in the gamification repository 120 to update the gamification state.

Progress event messages may be sent to one or more frontends 302, for example, in order to inform one or more players of changes in the gamification state. In some embodiments, the UI on the receiving device (e.g., mobile device, computer tablet, etc.) may respond to progress event messages. For example, the UI may unlock additional buttons or functionality based on the level the player has achieved, and vice versa, if the player's skill has degraded in some way. Such feedback allows the UI to adjust its functionality in conjunction with the player's abilities and skills.

Although event messages sent from the message broker 104 to the frontends 302 are generally intended for players, in some embodiments event messages may be consumed by the enterprise information system itself. For example, the enterprise information system may receive event messages relating to a sales person's progress. If the enterprise information system receives an event that indicates the sales person has received some achievement badge within the game, the enterprise information system may assign an additional role to the sales person or unlock some capability in the backend system of the enterprise.

As another example, in some embodiments, the enterprise information system may have already implemented, or is currently managing, a metric that is relevant to the gamification data. Rather than duplicating the metric in the gamification platform 102, the gamification repository 120 may be configured with information to access the metric from the enterprise system. An example of such a configuration is illustrated in FIG. 3A. Here, the enterprise information systems 322 and 324, each have respective data systems 322a and 324a. The figure represents a configuration where the gamification data may be distributed among data systems 322a and 324a, and the gamification repository 120. Accordingly, the gamification repository 120 may access gamification data stored in either data store 322a or 324a via the message broker 104. In an embodiment, for example, the gamification repository 120 may access data from and deposit data with the data stores 322a and 324a via event messages using the message broker 104.

Accordingly, in some embodiments, the gamification data may be distributed across multiple data systems in addition to (or perhaps instead of) the gamification repository 120. In order to maintain transparency within the gamification platform 102, the internal components of the gamification platform may always access gamification data via the gamification repository 120. If the gamification data is distributed, the gamification repository 120 would be responsible for managing data access among the multiple data storage systems.

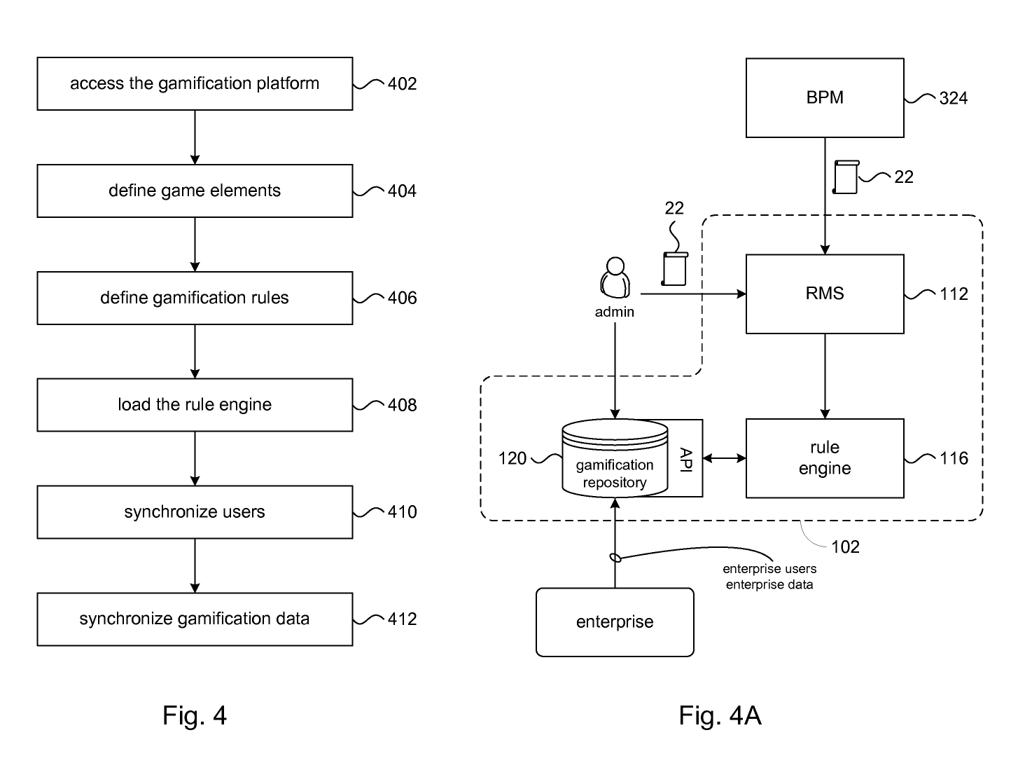

In some embodiments, the workflow for gamification system 100 includes a design time workflow and a runtime workflow. Referring to FIGS. 4 and 4A, an embodiment of a design time workflow will be described. In a step 402, an administrative user may gain access to the gaming platform 102. The administrative user may define, in step 404, various elements of the game. For example, the overall landscape of the gaming environment may be defined. The administrative user may define rewards to be offered. Player avatars may be designed, and so on. These elements may be stored in the gamification repository 120.

In a step 406, the administrative user may define the gamification rules 22, and provide the gamification rules to the RMS 112; e.g., in a rules file. In accordance with the present disclosure, the gamification rules 22 may be expressed in terms of events that may occur in the enterprise, or external events that are relevant to the enterprise; e.g., “when the player fulfills sales order X, the player gets 3 experience points.” In some embodiments, the gamification rules 22 may be defined in accordance with the business project management (BPM) model 324 of the enterprise information system 322, and more generally, the gamification rules may be calculated from business processes of the enterprise. In some embodiments, the gamification rules 22 may be derived automatically from the BPM 324. Such integration of the enterprise's business model vis-à-vis the BPM into the gamification platform provides a high degree of flexibility and agility for the business user. As changes are made to the BPM, so too will changes be made to the gamification rules 22 to maintain close correspondence between gaming dynamics and the enterprise's business model and processes. The RMS 112 may load the gamification rules 22 into the rule engine 116 in step 408. In some embodiments, the rule engine 116 may poll the RMS 112 to learn whether there are any changes to the gamification rules 22.

In a step 410, users in the enterprise may be synchronized with the gamification system 102 as “players”. In some embodiments, the administrative user may manually add users from the enterprise to the gamification platform 102; e.g., the gamification repository 120 may be used to store the players defined by an administrative user using the administrative UI 122. In some embodiments, users from the enterprise may be added to the gamification platform 102 via explicit gamification rules 22 for managing the addition and deletion of players. For example, the enterprise may send a “newUser” event message to the gamification platform 102. The event message may include all the metadata (e.g., user name, user's job title in the enterprise, their player name, initial settings, etc.) needed to register the user as a player in the gamification platform 102. A “deleteUser” event message may be defined to allow for a player to be deleted from the gamification platform 102. In other embodiments, players may be added in an ad hoc fashion if the enterprise information system cannot support a “newUser” event message. For example, the enterprise information system may simply send an event message that includes an unknown user ID. When such an event message is received, the user ID may be added to the gamification platform 102. Any additional data that may be needed for the added user may be obtained via an interaction between the gamification platform 102 and the user.

In a step 412, the administrative user may initiate a synchronization action to synchronize or otherwise import data from the enterprise information systems of the enterprise into the gamification platform 102. This step is optional and may be performed to initialize aspects of the gaming environment with metrics that are available from the enterprise. For example, carbon emission levels, allocated budget, and other pre-existing data from the enterprise may be relevant gamification data that can be stored in the gamification repository 120. This step may be performed any time that a new metric is developed in the enterprise information system that is deemed to be relevant gamification data.

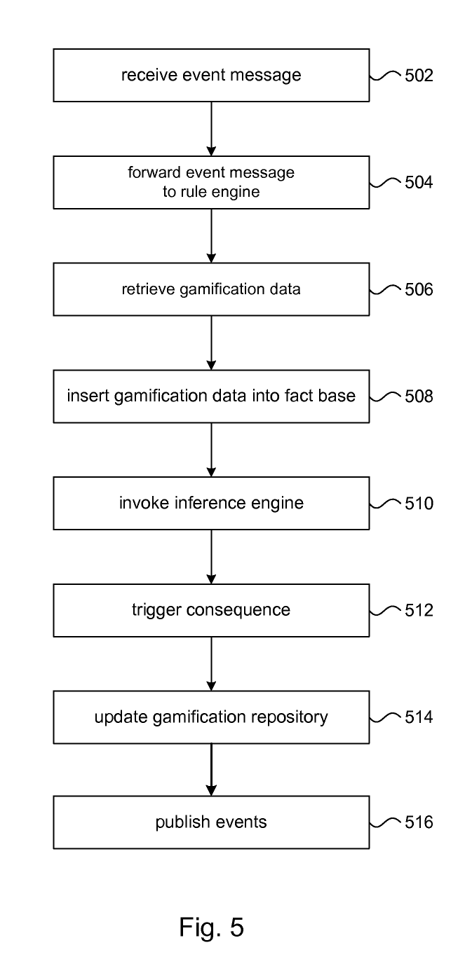

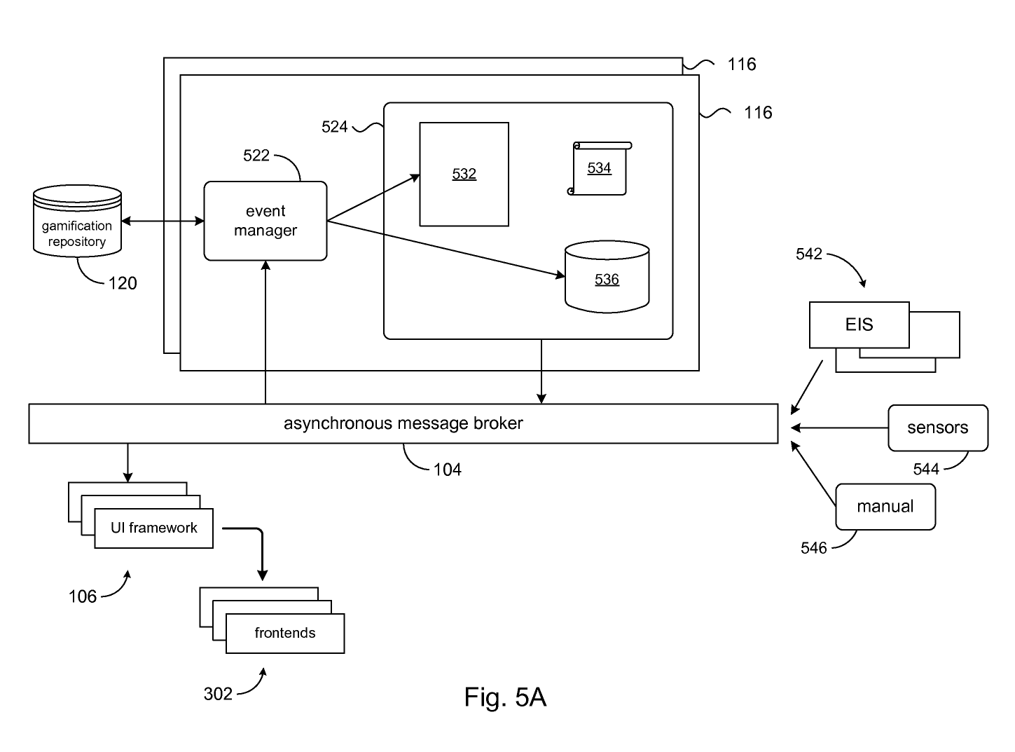

Referring to FIGS. 5 and 5A, an embodiment of the runtime workflow will be described. The runtime workflow highlights the processing that takes place when an event from the enterprise propagates into the gamification platform. The basic flow includes the message broker 104 receiving an event message from the enterprise information system(s) of the enterprise. The event message is forwarded to the rule engine 116, which processes the event message according to the gamification rules 22. As shown in FIG. 5A, the rule engine 116 may comprise an event manager 522 and a complex event processor 524. The complex event processor 524 may comprise an inference engine 532, a repository of rules 534, and a fact base 536.

Suppose an event eₓ in the enterprise occurs. For example, a business application 542 in the enterprise may detect the placement of a sales order, and in response may generate a SALES event message and communicate the event message to the message broker 104. In some embodiments, an event message may be generated by a sensor 544 or other automated device. For example, an event message may be sent when a sensor in a factory raises an alarm that machine x is broken; when a sensor informs that the airplane has taken off; when an alarm that a fire sprinkler in room #420 has been activated, and so on. In some embodiments, an event message may be generated manually 546. For example, the CEO of the enterprise decides to give all players 50 additional points; the last winner in an internal innovation contest receives a custom badge, and so on. In a step 502, the message broker 104 may receive the event message.

In a step 504, the message broker 104 may forward the event message to the rule engine 116. In a typical scenario, many players may be concurrently playing the game, and so the gamification system 100 is likely to be hit with many events as the players play the game and as events occur in the enterprise. Accordingly, in some embodiments, the gamification platform 102 may instantiate multiple rule engines 116 in order to accommodate high numbers of players in the enterprise and to process concurrent events coming in from the enterprise in order to provide adequate response time. For example, the message broker 104 may perform load balancing by distributing event messages across the multiple instantiations of rule engines 116. If a rule engine 116 is not available to process the event message, the message broker 104 may store the event message until a rule engine becomes available.

When the message broker 104 forwards the event message to a rule engine 116, the event message may be received by the event manager 522. In a step 506, the event manager 522 may retrieve gamification data from the gamification repository 120 based on data contained in the received event message. In accordance with the present disclosure, the current state of the game and the current state of its players may be incorporated in the gamification rules 22, in addition to events. Accordingly, the event manager 522 may access gamification data including state information about the player or players involved the event, the gamification state, and other information relevant to processing an event in terms of the current state (context) of the game. For example, relevant contextual information about the game or player may be that it is currently night time in the game, that three of the ten hidden treasures have been discovered, that player X is nearby, that player Y has 100 experience points, and so on. As will be discussed, the inference engine 532 may reason through the gamification rules 22 using such contextual information.

In a step 508, the event manager 522 may provide the retrieved gamification data to the complex event processor 524. In particular, the received event message and the retrieved gamification data may be loaded into the fact base 536 of the complex event processor 524. The gamification data may serve to initialize the fact base 536 with information (i.e., context) relating to the current state of the game that is relevant to the received event message.

In a step 510, event manager 522 may invoke processing in the inference engine 532 to reason if the received event message fulfills any of the gamification rules 22 using the received event message and the context loaded into the fact base 536. As explained above, the RMS 112 may store and manage several versions of gamification rules 22. Accordingly, the gamification rules 22 that are in play may be stored in the repository of rules 534 and accessed by the inference engine 532.

In accordance with principles of the present disclosure, the inference engine 532 may reason over multiple events and arbitrary relationships among events. The inference engine 532 may also take into account the current gamification state and previous gamification states. The inference engine 532 may reason over events related by logic, time, and space. For example, if event A occurred within 5 minutes of event B, then inference engine 532 may trigger a certain consequence. If event A occurred at location X, then trigger a consequence, but if event A occurred at location Y, then trigger another consequence. If event A occurred when player X has 100 experience points, then trigger a consequence. If event A and event B occur within 10 days of each other, and in respective locations X and Y, then trigger an event. If event A occurred when it is night time in the game, then trigger a consequence. And so on.

In a step 512, if a gamification rule is satisfied, then the inference engine 532 may trigger a consequence associated with the gamification rule, for example rewarding a player who made an achievement. However, it will be appreciated that consequences may involve any arbitrary action. A commerce type event may result in debiting a players virtual bank account when they purchase an item, for example. If a player uses a “cheat”, the player may be punished by a reduction in their experience points as a consequence. The inference engine 532 may generate one or more progress event messages to represent the consequence(s) triggered by a gamification rule.

In accordance with principles of the present disclosure, a gamification rule need not lead to a consequence with actions that immediately change the gamification state. For example, the consequence of a gamification rule may be to invoke another gamification rule. Consider, for example, a delayed award. Suppose a player performs a task X. The gamification rule for performing task X may be to invoke a time delay rule that waits for some amount of time to pass, say 24 hours. The time delay rule may then give the player their award when the 24 hours has passed. More generally, gamification rules may be nested, which is to say that one gamification rule, when triggered, may invoke another gamification rule, which in turn may invoke yet another gamification rule when triggered, and so on. The nesting of gamification rules allows a designer to specify a series of nested sub-goals that a player or players may have to achieve in order to win a prize.

In a step 514, the gamification repository 120 may be updated by the inference engine 532 to maintain a current gamification state, for example by publishing the progress events generated in step 512 into the message broker 104. The current gamification state (context) may be represented with state information about the game environment. For example, gamification state information may include state information that indicates time of day, season (summer, fall, etc.), current weather (raining, windy, etc.), and so on. The gamification state information may include state information about the state of structures in the game. For example, a building is on fire, a forest has X number of trees, a road has been traversed. The gamification state information may include state information about the state of items in the game; e.g., five treasures have been discovered by players, a door is open, a car is being driven, and so on. The gamification state information may include state information about the players in the game; e.g., their current location, game level, experience points, health, their possessions, achievements, and so on.

In a step 516, the progress event messages may be published to the message broker 104 and to be forwarded to players in the enterprise. In some embodiments, the players may register to receive certain progress events. For example, a sales person player may not be interested in progress events relating to implementation of an employee safety program by the human resource group. The sales person player may therefore designate to receive only progress events that relate to sales. Accordingly, the message broker 104 may perform some degree of filtering and distribution control to forward relevant progress events to each player according to the player's preferences. In addition, the player may simply turn off gamification, in which case the message broker 104 filters out all messages for that player. In some embodiments, the player may introduce an avatar to protect their identity. Accordingly, message passing by the message broker 104 may be influenced by the fact that the player has defined an avatar to represent them.

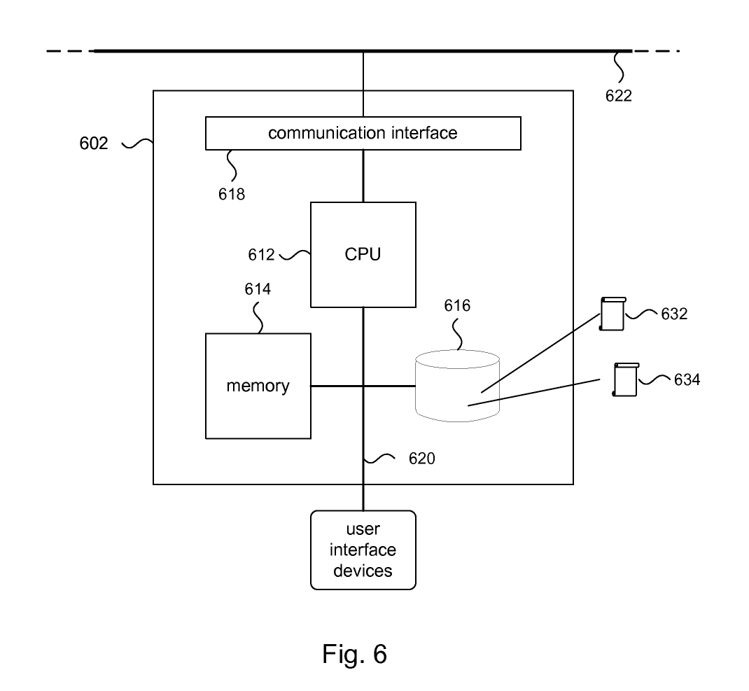

A particular embodiment of the gamification platform 102 in accordance with the present disclosure is illustrated in FIG. 6, which shows a high level block diagram of a computer system 602 configured to operate as the gamification platform. The computer system 602 may include a central processing unit (CPU) or other similar data processing component. The computer system 602 may include various memory components. For example, the memory components may include a volatile memory 614 (e.g., random access memory, RAM) and a data storage device 616. A communication interface 618 may be provided to allow the computer system 602 to communicate over a communication network 622, such as a local area network (LAN), the Internet, and so on. An internal bus 620 may interconnect the components comprising the computer system 602.

The data storage device 616 may comprise a non-transitory computer readable medium having stored thereon computer executable program code 632. The computer executable program code 632 may be executed by the CPU 612 to cause the CPU to provide the processing of the rule engine 116. For example, the CPU may perform the workflows shown in FIGS. 3 and 4. In some embodiments, the computer system 602 and computer executable program code 632 may provide virtualization capability to facilitate supporting multiple instances of the rule engine 116.

The data storage device 616 may store data structures 634 such as the gamification rules 22, and may serve as the gamification repository 120. In some embodiments, the data storage device 616 may comprise a separate storage system to serve as the gamification repository 120.

All systems and processes discussed herein may be embodied in program code stored on one or more non-transitory computer-readable media. Such media may include, for example, a floppy disk, a CD-ROM, a DVD-ROM, a Flash drive, magnetic tape, and solid state Random Access Memory (RAM) or Read Only Memory (ROM) storage units. It will be appreciated that embodiments are not limited to any specific combination of hardware and software. Elements described herein as communicating with one another are directly or indirectly capable of communicating over any number of different systems for transferring data, including but not limited to shared memory communication, a local area network, a wide area network, a telephone network, a cellular network, a fiber-optic network, a satellite network, an infrared network, a radio frequency network, and any other type of network that may be used to transmit information between devices. Moreover, communication between systems may proceed over any one or more transmission protocols that are or become known, such as Asynchronous Transfer Mode (ATM), Internet Protocol (IP), Hypertext Transfer Protocol (HTTP) and Wireless Application Protocol (WAP).

### ADVANTAGES AND TECHNICAL EFFECT

A gamification system in accordance with principles of the present disclosure provides a platform to gamify an enterprise by facilitating the integration of the enterprise's enterprise information system(s) with a gamification platform. The gamification system can provide immediate feedback to the enterprise users/players via progress events. The gaming environment provides a context that can present the enterprise's goals and challenges in an engaging and “fun” manner that encourages participation by the users. The gamification system can provide ranks/levels, time pressures, team building, virtual goods, gifts, marketplaces, and encourage competition among players. Additional game mechanics includes rewarding of points (such as experience points, redeemable points, etc.), managing a leader board, and so on.

The above description illustrates various embodiments of the present disclosure along with examples of how aspects of the present disclosure may be implemented. The above examples and embodiments should not be deemed to be the only embodiments, and are presented to illustrate the flexibility and advantages of the present disclosure as defined by the following claims. Based on the above disclosure and the following claims, other arrangements, embodiments, implementations and equivalents will be evident to those skilled in the art and may be employed without departing from the spirit and scope of the disclosure as defined by the claims.

APPENDIX
Gamification Rules Example

```
package example
global IAchievementUpdateAPI updateAPI;
global IAdminAPI adminApi;
declare EventObject
    @role(event)
    @timestamp(dateTime)
    @duration(eventDuration)
end
################# New User Rules ##########################################
rule “newUser”
    when
        $evt : EventObject(type==“new_user”) from entry-point eventstream
    then
        performance.debug(System.nanoTime( )+“;SEND;”+$evt.getType( )+“;”+$evt.getId( )+“;”+$evt.getEventObject( )+“;”+
$evt.getPlayerid( ));
        adminApi.createPlayer($evt.getPlayerid( ), $evt.getId( )); retract($evt);
end
rule “removeUser”
    when
        $p : Player($playerid:uid)
        $evt : EventObject(type==“delete_user”, playerid==$playerid) from entry-point eventstream
    then
        adminApi.deletePlayer($playerid); retract($evt);
end
rule “cleanMemoryOnUserRemoval”
    when
        $p : Player($playerid:uid)
        $del_evt : EventObject(type==‘delete_user’, playerid==$playerid) from entry-point eventstream
        $evt : EventObject(playerid==$playerid) from entry-point eventstream
then
        adminApi.deletePlayer($evt.getPlayerid( ));
        retract($evt); retract($del_evt); retract($p);
end
rule “newRideintent”
    when
        Player($playerid : uid)
        $evt : EventObject(type==‘new_rideintent’, playerid==$playerid, eventDuration==0) from entry-point eventstream
then
        EventObject obj = new EventObject( );
        obj.setType(“delayed_rideintent”);
        obj.setEventDuration(10*1000);
        obj.setPlayerid($playerid);
        obj.put(“mrid”, $evt.get(“mrid”));
        retract($evt);
        entryPoints[“internalstream”].insert(obj);
end
rule “deleteRideIntent”
    when
        $p : Player($playerid : uid)
        $ri : EventObject(type==‘delayed_rideintent’, playerid==$playerid) from entry-point internalstream
        $ri_delete : EventObject(type==‘delete_rideintent’, playerid==$playerid, data[‘mrid’]==$ri.data[‘mrid’], this during
$ri) from entry-point eventstream
    then
        retract($ri);
        retract($ri_delete);
end
rule “RIAfterDuration”
    timer(expr:$duration;)
    when
        $p : Player($playerid:uid)
        $ri : EventObject(type==‘delayed_rideintent’, $duration: eventDuration, playerid==$playerid) from entry-point
internalstream
then
        retract($ri);
        EventObject obj = new EventObject( );
        obj.setType(“pointEvent”);
        obj.setPlayerid($playerid);
        updateAPI.givePoints($p.getId( ), “Point”, 1, obj.getId( ));
end
rule “RIAfterRide”
    when
        $p : Player($playerid:uid)
        $ri : EventObject(type==‘delayed_rideintent’, playerid==$playerid) from entry-point internalstream
        $ar : EventObject(type==‘actual_ride’, playerid==$playerid, data[‘mrid’]==$ri.data[‘mrid’]) from entry-point
internalstream
    then
        EventObject obj = new EventObject( );
        obj.setType(“pointEvent”);
        obj.setPlayerid($playerid);
        updateAPI.givePoints($p.getId( ), ‘Point’, 1, obj.getId( ));
        retract($ri);
end
######################## Ride Rules ###############################
rule “RewardRideAsDriver”
    when
        $p : Player($playerid:uid)
        $ar : EventObject(type==‘actual_ride’, data[‘driver’]==‘true’,$carbon:data[‘carbon’], playerid==$playerid,
$rideid:data[‘rideid’]) from entry-point eventstream
    then
        EventObject evt = new EventObject( );
        evt.setType(“pointEvent”);
        evt.setPlayerid($playerid);
        updateAPI.givePoints($p.getId( ), “Point”, 5, evt.getId( ));
        evt = new EventObject( );
        evt.setType(“pointEvent”);
        evt.setPlayerid($playerid);
        updateAPI.givePoints($p.getId( ), “Carbon”, Double.parseDouble($carbon), evt.getId( ));
        EventObject obj = new EventObject( );
        obj.setType(‘rideEvent’);
        obj.setPlayerid($playerid);
        obj.put(‘rideid’, $rideid);
        entryPoints[‘internalstream’].insert(obj);
        retract($ar);
end
rule “RewardRideAsPassenger”
    when
        $p : Player($playerid:uid)
        Sar : EventObject(type==‘actual_ride’, data[‘driver’]==‘false’,
$carbon:data[‘carbon’],playerid==$playerid,$rideid:data[‘rideid’]) from entry-point eventstream
    then
        EventObject evt = new EventObject( );
        evt.setType(“pointEvent”);
        evt.setPlayerid($playerid);
        updateAPI.givePoints($p.getId( ), “Point”, 3, evt.getId( ));
        evt = new EventObject( );
        evt.setType(“pointEvent”);
        evt.setPlayerid($playerid);
        updateAPI.givePoints($p.getId( ), “Carbon”, Double.parseDouble($carbon), evt.getId( ));
        EventObject obj = new EventObject( );
        obj.setType(‘rideEvent’);
        obj.setPlayerid($playerid);
        obj.put(‘rideid’, $rideid);
        entryPoints[‘internalstream’].insert(obj);
        retract($ar);
end
rule “RideMatch”
    when
        $evt1:EventObject(type==‘rideEvent’, $rideid:data[‘rideid’], $playerid:playerid) from entry-point internalstream
        $evt2:EventObject(type==‘rideEvent’, data[‘rideid’]==$rideid, playerid!=$playerid, $playerid2:playerid) from entry-
point internalstream
        not(EventObject(type==‘socializerEvent’, playerid==$playerid, data[‘friendid’]==$playerid2) from entry-point
internalstream)
    then
        EventObject evt = new EventObject( );
        evt.setType(‘socializerEvent’);
        evt.setPlayerid($evt1.getPlayerid( ));
        evt.put(‘friendid’, $evt2.getPlayerid( ));
        entryPoints[‘internalstream’].insert(evt);
end
rule “Contacts+1”
    when
        $p : Player($playerid:uid)
        $evt : EventObject(type==‘socializerEvent’, playerid==$playerid, $friendid:data[‘friendid’]) from entry-point
internalstream
    then
        EventObject evt = new EventObject( );
        evt.setType(“pointEvent”);
        evt.setPlayerid($playerid);
        updateAPI.givePoints($p.getId( ), “Contact”, 1, evt.getId( ));
end
rule “WarriorBadge”
    when
        Player($playerid : uid)
        Number(intValue==3) from accumulate($evt : EventObject(type==‘new_rideintent’, playerid==$playerid) over
window:time(10s) from entry-point eventstream, count($evt))
    then
        updateAPI.addBadgeToPlayer($playerid, “Warrior Badge”);
end
```

What is claimed is:

1. A method in a gamification system comprising operating a computer in the gamification system to perform steps of:
producing gamification rules for a game operated by the gamification system, including receiving the gamification rules from outside the gamification system or calculating the gamification rules or both, the gamification rules being expressed in terms of detected events, gamification state information, and state information of players in the game, the gamification rules expressing temporal or spatial relationships among the detected events, the gamification state information, and the state information of the players;
storing the gamification rules in a gamification repository;
registering users in a business enterprise as players in the game;
detecting events that occur within the business enterprise and events that occur in the gamification system;
identifying a gamification rule based on one or more detected events and on temporal or spatial relationships among the detected events, a current gamification state information, and a current state information of the players;
triggering a consequence associated with an identified gamification rule, wherein the consequence includes generating an event or triggering another gamification rule; and
updating the gamification state information and the state information of one or more players.

2. The method of claim 1 wherein the gamification rules further express logical relationships among the detected events, the gamification state information, and the state information of the players.

3. The method of claim 1 wherein the gamification repository is distributed among a plurality of external storage devices outside the gamification system.

4. The method of claim 3 wherein some of the external storage devices are storage devices in the business enterprise.

5. The method of claim 1 further comprising sending to the business enterprise an event message that is associated with a consequence triggered from an identified gamification rule.

6. The method of claim 1 wherein the gamification rules are calculated from a business process management model of the business enterprise.

7. The method of claim 1 further comprising initializing the game environment with business information from the business enterprise.

8. The method of claim 1 further comprising detecting events that occur outside the business enterprise.

9. The method of claim 1 further comprising detecting a new player when a detected event is associated with a user ID that is not registered in the gamification system and in response thereto registering the new player by storing user information about the new player in the gamification system.

10. The method of claim 9 wherein the detected event is further associated with the user information about the new player.

11. The method of claim 9 wherein the detected event is not associated with any user information about the new player, wherein the method further comprises interacting with the new player to obtain user information from the new player.

12. The method of claim 1 wherein the gamification repository stores the gamification state information and state information of the players.

13. A gamification system comprising:
a computer system;
a communication interface for connection to one or more enterprise information systems; and
a data storage device having stored thereon executable program code, which, when executed by the computer system, causes the computer system to:
produce gamification rules for a game operated by the gamification system, including receiving the gamification rules from outside the gamification system or calculating the gamification rules or both, the gamification rules being expressed in terms of detected events, gamification state information, and state information of players in the game, the gamification rules expressing temporal or spatial relationships among the detected events, the gamification state information, and the state information of the players;
store the gamification rules in a gamification repository;
register users in a business enterprise as players in the game;
detect events that occur within the business enterprise and events that occur in the gamification system;
identify a gamification rule based on one or more detected events and on temporal or spatial relationships among the detected events, a current gamification state information, and a current state information of the players;
trigger a consequence associated with an identified gamification rule, wherein the consequence includes generating an event or triggering another gamification rule; and
update the gamification state information and the state information of one or more players.

14. The gamification system of claim 13 wherein the gamification rules further express logical relationships among the detected events, the gamification state information, and the state information of the players.

15. The gamification system of claim 13 wherein the gamification repository is distributed among a plurality of external storage devices outside the gamification system.

16. The gamification system of claim 13 wherein the executable program code further causes the computer system to send to the business enterprise an event message that is associated with a consequence triggered from an identified gamification rule.

17. The gamification system of claim 13 wherein the gamification rules are calculated from a business process management model of the business enterprise.

18. The gamification system of claim 13 wherein the executable program code further causes the computer system to detect a new player when a detected event is associated with a user ID that is not registered in the gamification system and in response thereto registering the new player by storing user information about the new player in the gamification system, wherein the user information is also associated with the detected event, or the user information is not associated with the detected event and is obtained from the new player.

19. A non-transitory computer readable storage medium having stored thereon computer executable program code, which, when executed by a computer system, causes the computer system to perform steps of:
producing gamification rules for a game operated by the gamification system, including receiving the gamification rules from outside the gamification system or calculating the gamification rules or both, the gamification rules being expressed in terms of detected events, gamification state information, and state information of players in the game, the gamification rules expressing temporal or spatial relationships among the detected events, the gamification state information, and the state information of the players;
storing the gamification rules in a gamification repository;
registering users in a business enterprise as players in the game;
detecting events that occur within the business enterprise and events that occur in the gamification system;
identifying a gamification rule based on one or more detected events and on temporal or spatial relationships among the detected events, a current gamification state information, and a current state information of the players;
triggering a consequence associated with an identified gamification rule, wherein the consequence includes generating an event or triggering another gamification rule; and
updating the gamification state information and the state information of one or more players.

20. The non-transitory computer readable storage medium of claim 19 wherein the gamification rules further express logical relationships among the detected events, the gamification state information, and the state information of the players.
